(19) United States
(12) Patent Application Publication
(10) Pub. No.: US 2012/0304941 A1
(43) Pub. Date: Dec. 6, 2012

(54) Pet Training Apparatus

(76) Inventor: Burke C. Marold, San Antonio, TX (US)

(21) Appl. No.: 13/149,072

(22) Filed: May 31, 2011

(51) Int. Cl. A01K 15/02; A01K 29/00

(52) U.S. Cl. 119/719

(57) ABSTRACT

A pet training apparatus comprising a closed cylindrical container having first and second walls connected to a cylindrical sidewall, wherein the interior surfaces of the first, second, and cylindrical walls define an cylindrical interior volume with a minimum inner diameter and a longitudinal axis, and a plurality of metallic objects with said interior volume. In the preferred embodiment, the metallic objects are spheroids (e.g., BBs or bearings), with each spheroid of being identical in size, shape, and density.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to pet training More specifically, the present invention is an apparatus and method for training a pet using negative reinforcement.

### BRIEF SUMMARY OF THE INVENTION

The present invention is a pet training apparatus comprising a closed cylindrical container having first and second walls connected to a cylindrical sidewall, wherein the interior surfaces of the first, second, and cylindrical walls define a cylindrical interior volume with a minimum inner diameter and a longitudinal axis, and a plurality of metallic objects with said interior volume. In the preferred embodiment, the metallic objects are spheroids (e.g., BBs or bearings), with each spheroid of being identical in size, shape, and density.

### BRIEF DESCRIPTION OF THE SEVERAL VIEWS OF THE DRAWINGS

FIG. 1 is a front partial sectional view of the preferred embodiment.

FIG. 2 shows the preferred embodiment of the invention in use.

### DETAILED DESCRIPTION OF THE INVENTION

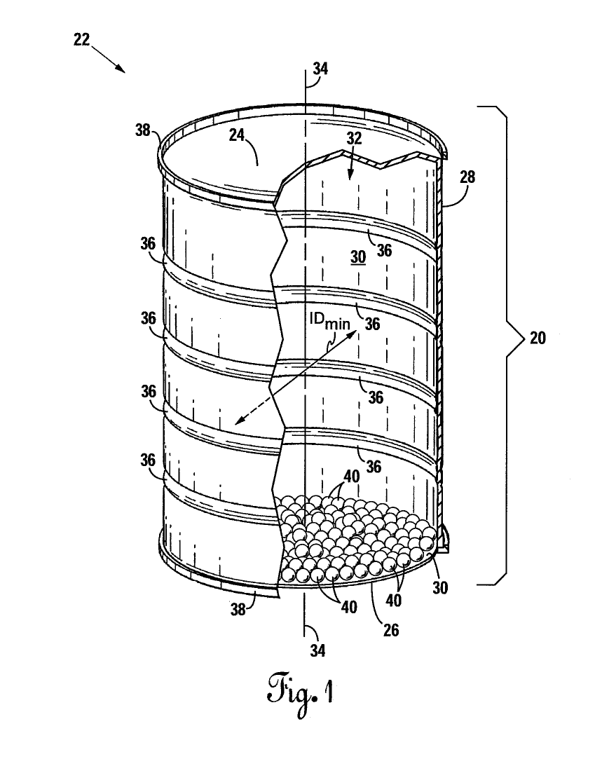

FIG. 1 is a front partial sectional view of the preferred embodiment 20 of the present invention, which comprises a generally-cylindrical closed container 22. The container 22 has opposing first and second walls 24, 26 and a continuous cylindrical sidewall 28. The interior surfaces 30 of the first wall 24, second wall 26, and sidewall 28 together define a generally cylindrical interior volume 32 having a longitudinal center axis 34. A plurality of ridges 36 are formed in the sidewall 28. The first and second walls 24, 26 include a rim 38 formed as part of the container-sealing process. The container 22 is sealed in a conventional manner (e.g., canning).

The volume 32 contains a plurality of members, which in the preferred embodiment are metallic spheroids 40, such as BBs or bearings. In the preferred embodiment, the spheroids 40 are of uniform size and density. The spheroids 40 are approximately 0.15″ in diameter. The minimum inner diameter IDₘᵢₙ of the sidewall is two and six tenths inches, but the inner diameter is larger within the ridges 36. The number of spheroids 40 is such that, when evenly distributed across a sidewall with the longitudinal axis parallel to the direction of gravitational force, no more than three levels of spheroids 40 accumulates.

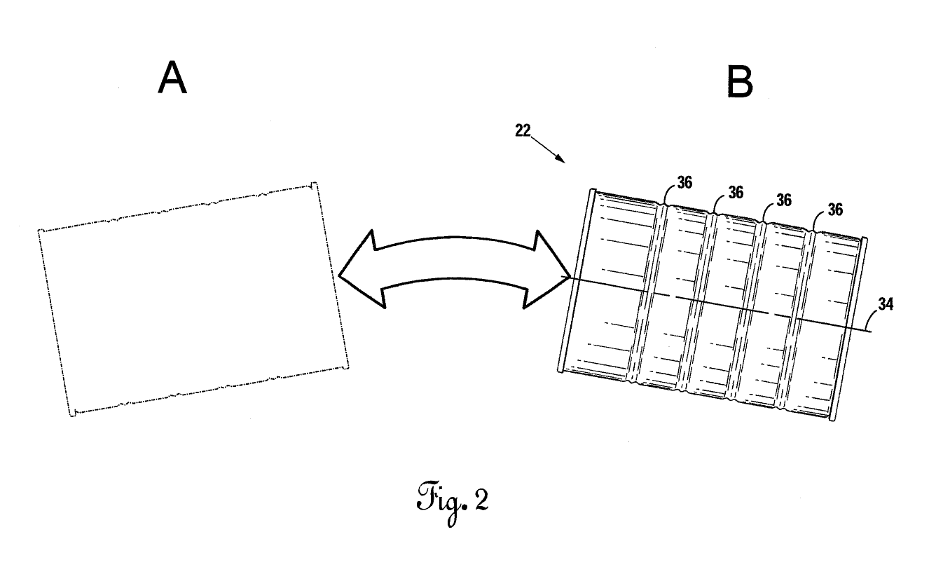

Use of the embodiment 20 is described with reference to FIG. 2. When a pet engages in undesirable behavior (e.g., barking, meowing, chewing, clawing, etc.), the user can grasp and firmly shake the container 22 together with issuing an audible signal, such as “No!” By shaking generally along the longitudinal axis 34 between positions A and B, the spheroids occupying the interior volume 32 will travel the length of the container 22 and contact the interior surfaces of the first and second walls 24, 26, as well as move along with the interior surface 30 of the cylindrical sidewall 28. The impacts of the spheroids 40 against the first and second walls 24, 26, as well as the other members, and the impact of the travel along the sidewall 28 and across the ridges 36, generates a loud noise heard by the pet. Combined with the audible negative reinforcement, the pet associates the noise with its undesirable behavior. Alternatively, the container 22 may be moved back and forth along in a direction transverse to the longitudinal axis 34.

The preferred embodiment comprises two hundred ninety BBs, with each BB having a diameter of fifteen one-hundredths of an inch. The interior diameter the interior volume of the cylindrical sidewall is 2.6″ inches. The height of the container is four inches.

The present invention is described in terms of preferred illustrative embodiments of a specifically-described pet training apparatus. Those skilled in the art will recognize that alternative embodiments of such a device can be used in carrying out the present invention. Other aspects, features, and advantages of the present invention may be obtained from a study of this disclosure and the drawings, along with the appended claims.

I claim:

1. A pet training apparatus comprising:
a closed cylindrical container having first and second walls connected to a cylindrical sidewall, wherein the interior surfaces of the first, second, and cylindrical walls define an cylindrical interior volume with a minimum inner diameter; and
a plurality of members with said interior volume.

2. The pet training apparatus of claim 1 wherein said objects are spheroids, each spheroid of said plurality of spheroids being identical in size, shape, and density to every other spheroid of said plurality of spheroids.

3. The pet training apparatus of claim 2 wherein said spheroids are BBs.

4. The pet training apparatus of claim 2 wherein the diameter of each spheroid is between five percent and seven percent of the minimum inner diameter.

5. The pet training apparatus of claim 2 comprising three or fewer levels of spheroids when the apparatus in a static state orientated with the longitudinal axis parallel to the direction of gravitational force.

6. The pet training apparatus of claim 2 wherein said plurality of spheroids comprises between two-hundred seventy and three-hundred ten spheroids.

7. The pet training apparatus of claim 2 wherein said plurality of spheroids consists of two-hundred ninety spheroids.

8. The pet training apparatus of claim 1 having at least one ridge formed in the cylindrical sidewall.
